(19) United States
(12) Patent Application Publication
(10) Pub. No.: US 2022/0268436 A1
(43) Pub. Date: Aug. 25, 2022

(54) WALLPAPER WITH INTEGRATED ELECTRICAL COMPONENTS

(71) Applicant: Amusing Inventions, Newcastle, WA (US)

(72) Inventor: John C. Gordon, Newcastle, WA (US)

(21) Appl. No.: 17/676,550

(22) Filed: Feb. 21, 2022

Related U.S. Application Data
(60) Provisional application No. 63/151,752, filed on Feb. 21, 2021.

(51) Int. Cl. F21V 33/00; F21S 2/00; F21V 23/00; D21H 27/20

(52) U.S. Cl. CPC F21V 33/006; F21S 2/00; F21V 23/001; D21H 27/20; F21Y 2115/10

(57) ABSTRACT

A wallpaper system may include a sheet of material comprising a top layer comprising a decorative material, a bottom layer to be adhered to a surface, and an intermediate layer located between the top layer and the bottom layer. In some examples the wallpaper system may include an electronic component coupled to the sheet of material and a conductor disposed within the intermediate layer. The conductor may be coupled to the electronic component and may be configured to provide power to the electronic component.

### CROSS-REFERENCE TO RELATED APPLICATIONS

This application claims the benefit of priority to and is a non-provisional application of U.S. Provisional Patent Application No. 63/151,752, filed on Feb. 21, 2021, the entire contents of which are incorporated herein by reference.

### BACKGROUND

Many buildings include electrical wiring located within the interior of the walls of the building to allow for configuration of lighting and other electronic components. For example, light fixtures, receptables, and switches typically protrude through the interior and exterior of the walls to provide access to the electrical wires. Thus, modification or alteration of such wiring, lighting, and/or electronic components typically requires the service of an electrician or other contractor, and often causes permanent damage to the walls. Thus, homeowners and renters may wish to incorporate lighting or other electronic components without the use of professionals or without altering current structures.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates a front view of an example configuration of a system including a circuit comprised of multiple wallpaper modules including integrated electronic components.

FIG. 2 illustrates a schematic view of an example circuit of a wallpaper module.

FIG. 3 illustrates an alternative schematic view of an example wallpaper module including multiple docks for connecting electronic components.

FIG. 4 illustrates a side view of an example wallpaper module including an example dock for coupling an electronic component (in this case a switch).

FIGS. 5A-5D illustrate schematic views of example switches that may be coupled to a wallpaper module.

FIG. 6 illustrates a schematic diagram of an example cable routing sheath that may be integrated into a wallpaper module in a circuit.

FIGS. 7A-D are schematic diagrams illustrating contact points and electrical interfacing docks for connecting electronic components to a module, for connecting adjacent modules to one another, and/or for connecting a module to a conduit or other component, such as cable routing sheath.

### DETAILED DESCRIPTION

As discussed above, existing solutions for installing and/or changing locations of electronic components present challenges. For example, many buildings contain wiring located within the walls of the building. Such wiring may be routed through interior holes, conduits, and/or chases to connect to alternating current (AC) electricity sources, such as those supplied to the building by an electricity provider (e.g., utility company or local generation source). The electricity sources may be connected to the wiring in the walls via a meter and/or electrical panel, for example. While building wiring is typically located within the walls, fixtures, lights, receptacles, switches, and other electronic components are commonly located outside of the walls (e.g., on a surface of the wall). In some examples, these fixtures may protrude through a surface or sheeting (e.g., drywall, plaster, plywood, etc.) of the walls to provide access to the electrical wiring located within. However, because the electrical wiring is integrated within the interior of the walls, modifying the location of fixtures traditionally requires the use of a professional, such as an electrician or contractor, to manually penetrate the wall to access the interior wiring. Not only may this process be undesirable for some, in the case of home renters, but it may also be prohibited.

In some applications, battery-powered standalone lights, such as those including light-emitting diodes (LEDs), may be used to offer temporary lighting solutions (e.g., night lights, reading lights, emergency lighting, etc.). For example, LED lights may be mounted and secured to provide battery-operated lighting solutions. However, these lights are typically designed to illuminate small, localized areas. Because LED lights are separately switched, they must be turned off and on individually, and are not practical for illuminating large areas.

This application describes systems and techniques for removable electronic components (herein referred to as “wallpaper modules”) that may be added to any interior space without permanent consequences by routing circuits outside of (e.g., on a surface of) the walls, rather than through them. While examples are described with respect to walls, the systems and techniques described herein may be applied to any surface, such as ceilings, floors, windows, furniture, and vehicles, to name a few examples.

For example, a user may wish to install a light fixture in a room in their home. However, the user may rent the home and be prohibited from making any permanent changes to the walls of the home. Thus, the user may rely on the wallpaper module for integrating additional light fixtures in the room by routing circuits on the surface of the walls, rather than through them, thus maintaining the integrity of the existing walls and not permanently altering the walls.

The wallpaper module may include one or more layers comprising one or more conductive materials that, when coupled with electronic components, may form one or more circuits that may activate the one or more electronic components when supplied with power. For example, the one or more layers may include one or more materials (e.g., ink and/or adhesive) deposited or printed on a substrate or other material of another layer. In some examples, the wallpaper module may contain a top layer. The top layer may be decorative and may be outward-facing, such that it may be visible when mounted to a surface. In some examples, the top layer may comprise a dielectric material, which in some examples may be grounded. The wallpaper module may further contain a bottom layer that may be adhered to the surface. For example, the bottom layer may be configured to adhere to a wall, a ceiling, a window, a door, a vehicle, and/or furniture, to name a few non-limiting examples. In some examples, the bottom layer may comprise a removable adhesive such that the bottom layer may be removed from the surface without causing damage to the surface to which it is adhered. In other examples, the adhesive may be applied to the sheet of material and/or the surface to which the wallpaper module is to be attached prior to the installation of the other sheets of the wallpaper module and/or the electronic component(s). Additionally, the wallpaper module may contain one or more intermediate layers disposed between the top layer and the bottom layer. In some examples, the conductor may be disposed within or on at least one of the top layer, the intermediate layer, and/or the bottom layer. Additionally, the conductor may be coupled to the electronic component and may be configured to provide power from a power supply to the electronic component.

In one specific example, a wallpaper module may include an intermediate layer of flexible, compliant material, a top layer of ink deposited on the intermediate layer, and a bottom layer of adhesive disposed between the intermediate layer and a wall or other support surface to which the wallpaper module is to be coupled. In such an example, the adhesive layer may be applied to an underside of the intermediate layer and/or to the wall or other support surface prior to application of the wallpaper module. In some examples, the adhesive layer may include one or more conductive traces formed with conductive paste, resin, wires, and/or metal foil disposed in the adhesive layer. Additionally or alternatively, the intermediate layer may have one or more conductors disposed in or on the intermediate layer (e.g., wires, traces, metal foils, etc.). Additionally or alternatively, the top layer of ink may comprise a conductive ink that is configured to transmit electricity. In some examples, conductors in the top layer, bottom layer, and/or intermediate layers may be electrically insulated from one another by intervening dielectric material, while in other examples, the conductors in the top layer, bottom layer, and/or intermediate layers may be electrically connected at one or more locations by a bridge, via, or other inter-layer electrical connection.

In some examples, the wallpaper module may contain one or more docks disposed in or on the sheet of material. The dock(s) may couple electronic component(s) to the conductor of the wallpaper module. For example, the dock(s) may be configured to electrically and/or physically couple the wallpaper module to one or more electronic components and/or adjacent wallpaper modules, allowing for electronic components and/or wallpaper modules to be placed in a variety of locations. The dock(s) may be standardized and multiple different types of electronic components (e.g., lights, receptacles, switches, etc.) may be configured to couple to any or all of the docks. In some examples, a dock may include a closed connection, such that if nothing is coupled to the dock, the dock may function as an electrical conductor. However, when an electronic component is coupled to the dock, the dock may become electrically open, allowing electricity to pass through the electronic component or to be switched and/or regulated by the electronic component.

In some examples, the dock may include a magnetic disconnect. For example, when no electronic components are connected, the dock may remain in a normally closed state. When an electronic component is connected, the dock may transition to an electronically open state. Additionally or alternatively, the dock may include a steric-based disconnect. For example, when an electronic component is connected, the dock may be forced apart, transitioning the dock from electrically closed to electrically open.

In some examples, the electronic component may include any number of different types of devices or components that may be coupled to the wallpaper module. For example, an electronic component may be any electrical device that uses or provides electricity. The electronic component may an analog component or a digital component. By way of example and not limitation, the electronic component may comprise at least one of a light, a receptacle, a switch, a sensor, a motor, a speaker, a coupler, a disconnect, a dock, a power supply, a processor, a memory, a wired communication connection, a wireless communication connection, a capacitor, an inductor, a resistor, or an amplifier, or combinations of any of the foregoing, to name a few non-limiting examples. In some examples, the electronic component may be specifically manufactured to couple to the wallpaper component (e.g., via one or more of the docks). Alternatively, the wallpaper module may be configured to couple to conventionally available electronic components.

In some examples, the sheet of material may comprise at least one of a wallpaper, a fabric, and/or a sticker. For example, a top layer of the wallpaper module may be outward-facing, such that when the wallpaper module is adhered to a surface, the top layer may be visible or exposed. The sheet of material may be decorative and may contain one or more patterns or designs, similar to traditional wallpaper. For example, the sheet of material may be smooth, textured, colored, and/or able to be painted or otherwise decorated.

In some examples, the wallpaper module may be flexible and compliant such that it can generally conform to the supporting surface to which it is applied. For example, at least one of the top layer, the intermediate layer, and/or the bottom layer may include reinforced fiber (e.g., fiber-reinforced with glass, cellulose, carbon, metal, and/or other natural or synthetic fibers). In such cases, the fibers may be woven or non-woven. Further, the wallpaper module may include various configurations of layers depending on an intended use of the wallpaper modules. For example, the wallpaper module may contain a different number of layers, different positions of the layers, and/or different combinations of layers, to name a few examples.

In some examples, the electronic component may be coupled to at least one of the top layer, the bottom layer, and/or the intermediate layer by at least one of a conductive paste, a conductive fastener, and/or a conducive hook and loop. The techniques discussed herein significantly improve the installation of electronic components in a home or other building without modifying or damaging the underlying walls or other supporting surfaces. Additionally, in some examples, the sheets of material can be removed, repositioned, and reused again and again. Because the sheets of material can be removed, a user can take them with them when they move.

The techniques described herein may be implemented in a number of ways. Example implementations are provided below with reference to the following figures. Further, the techniques described herein are not limited to the specific examples shown in the figures. Although discussed in the context of wallpaper, the methods, apparatuses, and systems described herein may be applied to a variety of locations and are not limited to wallpaper. A few other examples include floor coverings, window screens or coverings, vehicle coverings, or any other surface to which a covering or layer can be applied.

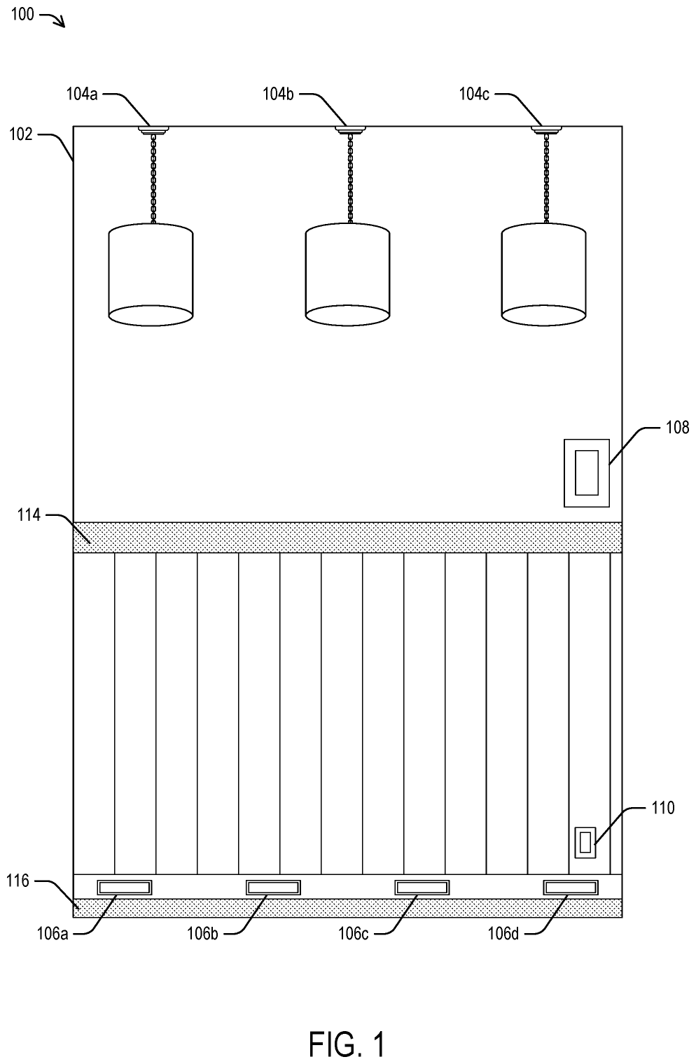

FIG. 1 illustrates a schematic view of an example system 100 including one or more wallpaper modules with integrated electronic components. As used herein, a “wallpaper module” includes a discrete assembly that can be used alone or in combination with one or more other wallpaper modules to provide power to lighting and other electronic components. The wallpaper modules can be adhered to a surface and physically and/or electrically connected to one another. The example system 100 shown in FIG. 1 is implemented using a single wallpaper module, though in other examples the same configuration could be implemented using multiple wallpaper modules coupled together (e.g., a first/upper wallpaper module disposed above chair railing 114 electrically connected to a second/lower wallpaper module disposed below the chair railing 114). Although seven electronic components are depicted, it may be noted that any number of one or more electronic components may be used with the system. Wallpaper modules, as illustrated in FIG. 1, may be used in a variety of ways. For example, the system 100 may include a substrate 102 which may be configured to provide insulation and/or conduct electricity between the wallpaper modules. The substrate 102 may include one or more layers and may comprise one or materials. In some examples, the substrate 102 may include one or more electrically conductive materials, such as aluminum, aluminum nitride, copper, silver, electrically conductive polymers, etc. The electrically conductive materials may in some examples be in the form of wires, traces, thin foils, or sheets which are disposed in or on a carrier or backing which provides a structural integrity to the substrate 102. In some examples, the substrate may also include one or more insulative materials, such as beryllium oxide, polytetrafluoroethylene, polyimide, polyetheretherketone (PEEK), fire retardant materials (e.g., FR-4) composite epoxy materials (e.g., CEM-1, CEM-2, and CEM-3), and ceramic laminate (e.g., RF-35), to name a few non-limiting examples. The insulative materials, when present, may be disposed between individual wires, traces, sheets, layers, and/or strips of the conductive materials.

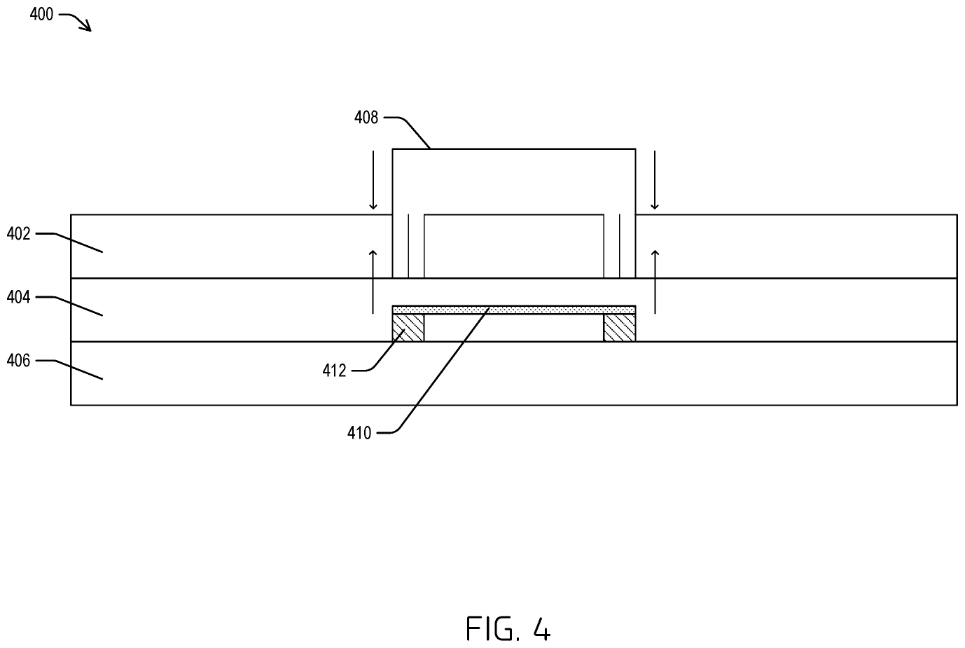

In some examples, the system 100 may contain one or more wallpaper modules, which may be configured to receive one or more electronic components. The electronic components may be any of the example components described throughout this disclosure, such as a fixture (e.g., a ceiling light, a wall sconce, a lamp, a fan), a receptacle, a switch, a sensor, a motor, a speaker, a coupler, a disconnect, a dock, a power supply, a processor, a memory, a wired communication connection, or a wireless communication, to name a few non-limiting examples. Additionally, the wallpaper modules may be fixed to any surface, such as a wall, a ceiling, a window, or furniture, to name a few non-limiting examples. As depicted in FIG. 1, the system 100 contains overhead lamps 104a, 104b, and 104c, which may be fixed to a surface (such as a ceiling of a room), and floor lights 106a, 106b, 106c, and 106d (which may be fixed to a wall of the room) via the wallpaper module. The electronic components may be coupled to one or more layers of material, such as the substrate 102, which is described in more detail in FIG. 4. In some examples, the electronic components may be connected via one or more wires, traces, or other electrically conducive materials of the substrate 102.

To operate the electronic components, the system 100 may contain one or more switches, such as overhead lamp switch 108 and LED switch 110. In some examples, the one or more switches may be at a location separate from the corresponding electronic components. As depicted in FIG. 1, the one or more switches may contain a physical switch facade such that a user may manipulate the electronic components. For example, the switch may be a single-pole light switch, such that a user may turn one or more of the electronic components on and off by physically moving a lever on the overhead lamp switch. However, the overhead lamp switch may be any number of switches, such as a multiple-location switch, which may allow multiple switches to control the one or more electronic components; a programmable-timer switch, which may allow a user to customize a time in which the electronic components will turn off and on; and/or a dimmer switch, which may allow the user to change a brightness of the one or more electronic components. Additionally or alternatively, the switch may be an occupancy switch, which may turn the electronic components off or on when light and/or motion is detected. In some examples, the switch may include or be electrically coupled to a controller configured to activate or deactivate the electronic component(s) based on one or more inputs (e.g., voice inputs, gesture inputs, motion sensor inputs, etc.).

In some examples, the system 100 may contain trim, such as chair railing 114 and/or baseboard trim 116 which may be configured to hide wires or traces connecting the wallpaper modules by using decorative elements. For example, a user may route the wires or traces under a hollow trim.

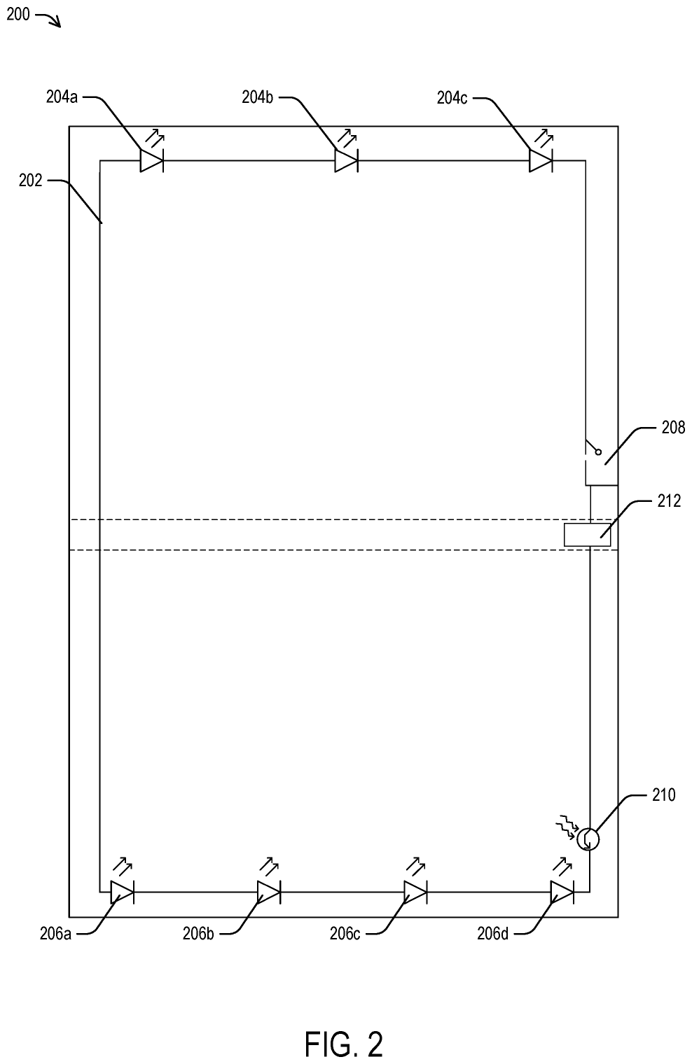

FIG. 2 illustrates a schematic view of an example circuit 200 of the wallpaper module of FIG. 1. That is, the circuit 200 represents an example of the electrical conductors (wires, traces, etc.) underlying the system 100, illustrated in FIG. 1. For instance, the circuit 200 may be disposed in a substrate of the system 100, which includes conductive materials (e.g., wires, traces, etc.) to connect to one or more electronic components.

In some examples, the circuit 200 may contain a first set of LEDs 204a, 204b, and 204c associated with the overhead lamps 104a, 104b, and 104c shown in FIG. 1 and a second set of LEDs 206a, 206b, 206c, and 206d associated with the floor lights 106a, 106b, 106c, and 106d shown in FIG. 1.

Similar to that described with respect to system 100 in FIG. 1, the circuit 200 may contain multiple switches. For example, the circuit 200 may contain a first switch 208 electrically connected to control actuation of the first set of LEDs 204a-204c for the overhead lamps and a second switch 210 electrically connected to control the second set of LEDs 206a-206d. The switches 208 and 210 may be any of the types of switches described throughout this disclosure. In one particular example, the switch 208 may comprise a physical rocker switch that can be manually switched on or off by a user, while the second switch 210 may be a relay switch, which is governed by an external signal applied to the relay, such as light and/or motion. For example, the relay switch may include a passive infrared sensor such that a detection of motion may trigger the relay to complete the circuit to actuate the second set of light sources 206a-206d of the floor lights 106a-106d. In other examples, the relay switch may be connected to a receiver which may trigger in response to radio frequency waves, light pulses, or other signals.

In some examples, the circuit 200 may include one or more power supplies, such as power supply 212, which may be used to provide, convert, and/or condition electrical energy provided to the one or more electronic components. For example, the power supply may be used to provide AC and/or DC power to the electronic components. In some examples, the power supply may be physically coupled to a wallpaper module, such that the wallpaper module contains the power supply. Additionally or alternatively, the wallpaper module and the power source may be separate from one another. In some examples, the power supply may include a direct DC source such as a battery, a solar panel, and/or a thermoelectric generator, to name a few non-limiting examples. The power supply may additionally or alternatively receive AC mains power supplied by an existing receptacle and/or junction box in a wall or other support surface. The AC mains power may be converted to low voltage DC (e.g., 3-12 volts) to power the electronic components in the wallpaper module. However, in other examples, the AC mains power may be used to power one or more electronic components directly (e.g., without conversion).

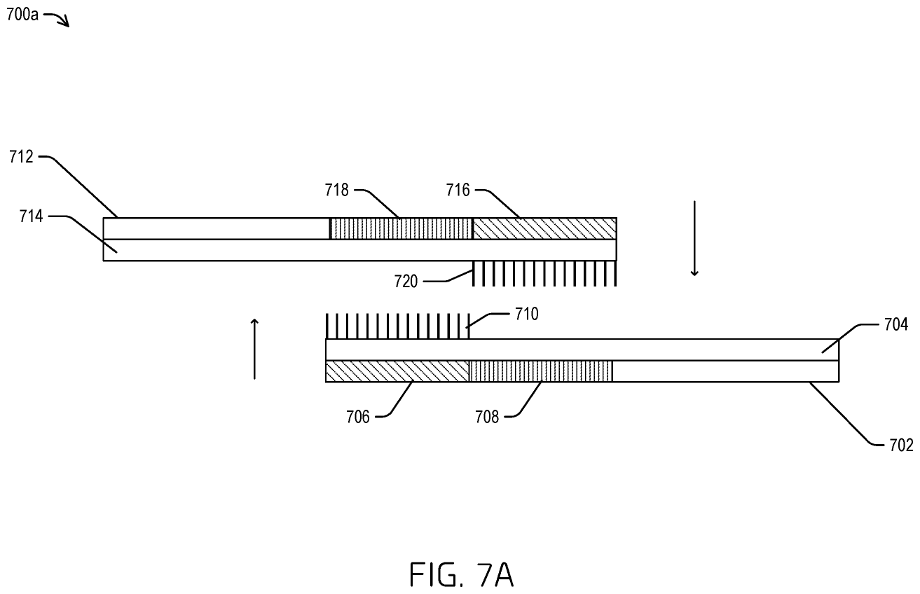

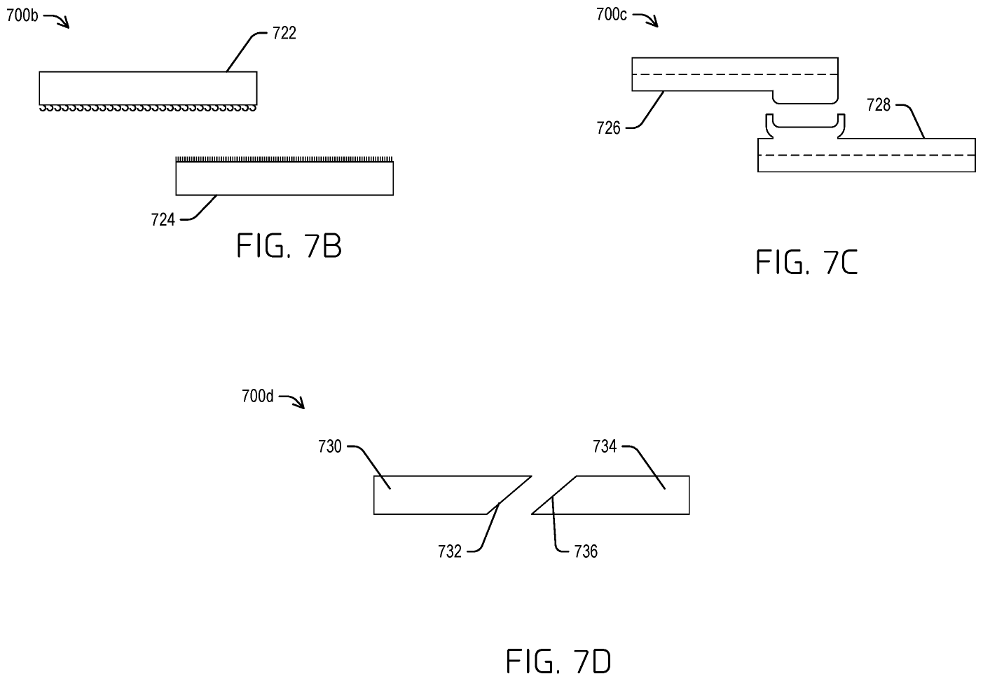

In some examples, the circuit disposed in the wallpaper module may include zones for positive and negative conductors (e.g., traces disposed in a top of the module may be positive and traces in the bottom portion may be negative) and circuits may be laid out in parallel or in series, and may include one or more capacitive couplings. The power supply may be coupled to multiple wallpaper modules, as described in further detail in FIGS. 7A-7D. For example, the multiple wallpaper modules may be disposed in parallel, such that each additional wallpaper module may add a new circuit, thus reducing a resistance and increasing a current between the multiple modules. In this example, the power supply may be coupled to the multiple wallpaper modules via one or more symmetric panels that may be optionally interfaced with a DC source, allowing the power supply to extend over a distance.

In some examples, the multiple wallpaper modules may be disposed in series. For example, instead of bridging positive and negative lines, each wallpaper module may be attached to a same line, and each additional wallpaper module may add a power load to the same circuit. Coupling multiple wallpaper modules in series may allow a large quantity (e.g., 10, 15, 20, etc.) of wallpaper modules to be connected. In some examples, the power source may be coupled to multiple wallpaper modules in a series inline from a transformer. In some cases, a transformer may be attached to the wallpaper module last in the series.

Additionally or alternatively, the multiple wallpaper modules may be connected via capacitive coupling. For example, the wallpaper modules may be configured to allow an AC line to run through the multiple modules. Further, a transformer may be printed on one or more of the wallpaper modules, allowing for adjacent AC-DC conversion. Thus, when the multiple wallpaper units are overlaid, the transformer of a sufficiently close adjacent wallpaper module may drive a current, allowing the current to be passed from one wallpaper module to the next, adjacent wallpaper module.

In some examples, the power provided by the power supply may be rectified, regulated, stepped down using a transformer, or otherwise conditioned to meet the needs of the electronic components. For example, AC main power may be sourced from a wall outlet. To convert the AC mains power to DC, an AC to DC converter may be integrated into the circuit. For example, the AC to DC converter may be integrated directly into the wallpaper module and positioned to sit flush with the wall outlet. Alternatively, the AC to DC converter may be integrated into a structural element, such as a junction box or light fixture, to name a few examples.

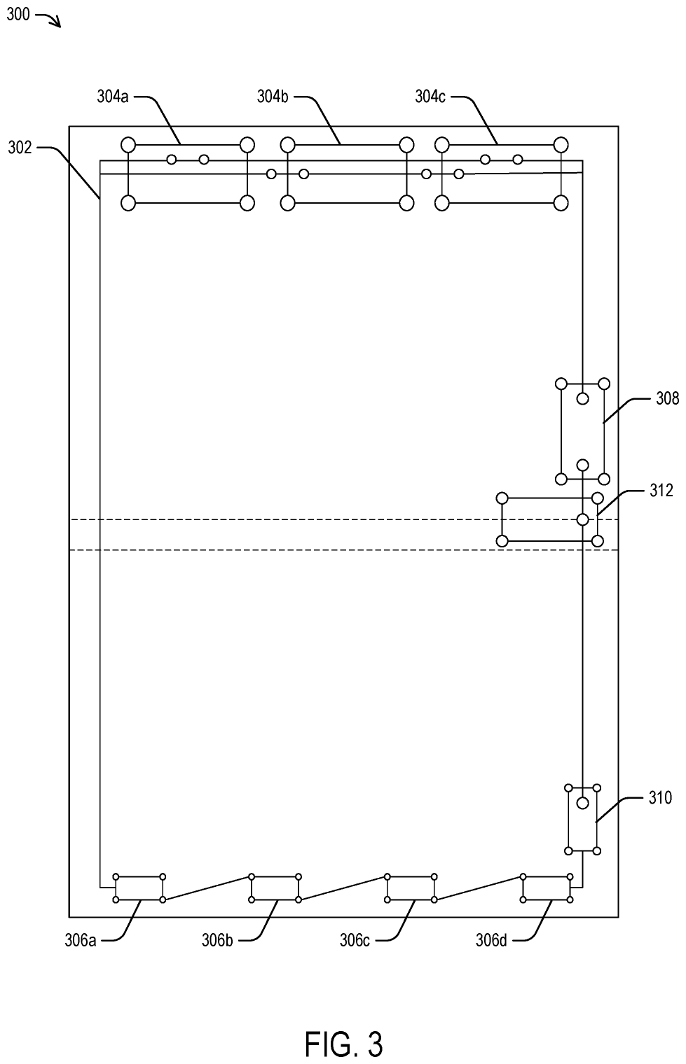

While not shown in this example, the circuit 200 may additionally or alternatively include one or more docks or other electrical connections to which appliances or other electronic components can be coupled (described in more detail with reference to FIGS. 3-6), to couple the circuit 200 to an external power supply, and/or to couple the circuit 200 to circuits in one or more other wallpaper modules (as described in more detail with reference to FIGS. 7A-7D).

Although the circuit 200 in this example is a single simple circuit, the circuit may be of any complexity and size, may include any number of conductors (e.g., wires, traces, etc.) electrically connecting any number of electronic components to a power supply. Additionally, in some examples, a single wallpaper module may include multiple circuits in a variety of configurations.

FIG. 3 illustrates a schematic view of an example circuit 300 including multiple docks. The circuit 300 may be the same or similar as the circuit 200 illustrated in FIG. 2. For example, a circuit may contain one more substrates 302 and/or one or more wallpaper modules. The wallpaper modules may include one or more connections or “docks” disposed at various locations throughout the circuit. The docks may be standardized and may be configured to connect to electrically and/or physically couple to one or more electronic components and/or adjacent wallpaper modules, allowing for wallpaper modules to be placed in a variety of locations. In some examples, a dock may include a closed connection, such that if nothing is coupled to the dock, the dock may function as an electrical conductor. However, when an electronic component is coupled to the dock, the dock may become electrically open, allowing electricity to pass through the electronic component (in the case of an electrical load, such as a light or a motor, for example), or to be switched and/or regulated by the electronic component (in the case of a switch or dimmer, such as a manual switch, a touch sensor, a photosensor, or a motion sensor, for example). In some examples, the dock may include a magnetic disconnect. For example, when no electronic components are connected, the dock may remain in a normally closed state. When an electronic component is connected, the dock may transition to an electronically open state. Additionally or alternatively, the dock may include a steric-based disconnect. For example, when an electronic component is connected, the dock may be forced apart, transitioning the dock from electrically closed to electrically open.

In some examples, the electronic components may be physically coupled to the docks. For example, the circuit 300 may include docks 304a, 304b, and 304c, which physically and electrically couple to overhead lamps 104a, 104b, and 104c, and docks 306a, 306b, 306c, and 306d, which physically and electrically couple to floor lights 106a, 106b, 106c, and 106d, as illustrated in FIG. 1. The circuit 300 may additionally or alternatively include docks 308, 310, and 312, which physically and electrically couple to switches 208 and 210, and power supply 212, respectively.

The electronic components may couple to the docks in a variety of ways, such as magnetic attachment, fasteners, latches, snap fits, hook and loop attachments, etc. For example, in the case of a magnetic attachment, the dock may contain one or more magnets and/or electromagnets, and the electronic component may contain one or more ferromagnetic materials, such that when the ferromagnetic material is subject to the magnetic field of the one or more magnets, the ferromagnetic material responds with an opposite magnetic field and is drawn to the one or more magnets. Alternatively, the dock may contain one or more ferromagnetic materials and the electronic component may contain one or more magnets and/or electromagnets. In some examples, the electronic components may additionally or alternatively be coupled to the docks by fasteners (e.g., nails, screws, staples, rivets, brads, etc.), snap-fit connections, press-fit connections, adhesives, or hook and loop fasteners, to name a few non-limiting examples. Some example fastening mechanisms are discussed in more detail with reference to FIGS. 7A-7D.

In some examples, the one or more docks may be spaced at a distance from one another (e.g., 1 inch, 1.5 inches, 2 inches, etc.) to prevent the docks from being interfaced backward and/or to prevent the circuit from short-circuiting. For example, a dock having a higher current carrying capacity may require a larger width trace (or a conductor with a larger cross-sectional area), which may translate to a wider spacing between the one or more docks. In some examples, a ratio of a distance between the one or more docks and one or more conductive elements (e.g. wires, traces, etc.) of the substrate may be greater than a width of the one or more conductive layers (e.g., 1× larger, 1.5× larger, 2× larger, etc.).

FIG. 4 illustrates a cross-sectional side view of an example wallpaper module 400 including a dock and a switch. The wallpaper module 400 module may be the same or similar to any of the wallpaper modules described in FIGS. 1-3. The wallpaper module 400 may contain multiple layers. In some examples, the one or more layers may be made of a transparent or translucent material (e.g., plastic and/or glass) such that the underlying supporting surface may be visible through the wallpaper module. For example, the wallpaper module may be coupled to an electronic component, such as a lamp, which may emit light through the wallpaper module. Thus, the one or more transparent and/or translucent layers may function as a waveguide or diffuser to transmit, refract, and/or diffuse light emitted by the lamp.

In some examples, the wallpaper module may contain a top layer, such as top layer 402, one or more intermediate layers, such as intermediate layer 404, and a bottom layer, such as bottom layer 406. For example, the top layer may be outward-facing, such that when the wallpaper module is adhered to a surface, the top layer may be visible. The top layer may be decorative and may contain one or more patterns or designs, similar to traditional wallpaper. For example, the top layer may be smooth, textured, colored, and/or able to be painted or otherwise decorated. In some examples, the top layer may comprise a grounded shielding layer to protect users from electrical shock when contacting an exterior surface of the wallpaper module.

In some examples, the bottom layer may include an adhesive material (e.g., a pressure-sensitive adhesive, a wallpaper adhesive, etc.) to adhere the wallpaper module to a supporting surface, such as a wall, a ceiling, a floor, a window, or a vehicle to name a few examples. In other examples, the bottom layer may be electrostatically charged and configured to adhere to the supporting surface by electrostatic forces. For example, examples, the wallpaper module may include a removable, protective backing encompassing at least a portion of the bottom layer. Prior to attachment to the supporting surface, the protective backing may be removed, exposing the electrostatically charged surface of the wallpaper module, which may be attracted to and removably adhere the wallpaper module to the supporting surface.

In some examples, the wallpaper module may contain one or more intermediate layers disposed between at least a portion of the top layer and/or the bottom later. The one or more intermediate layers may be comprised of one or more conductive materials, insulative materials, and/or semiconductor materials (e.g., metal films, doped graphene, doped silicon, doped geranium, doped silicon, and/or deposited copper, silver, and/or tin nanoparticles on a high dielectric substrate such as paper and/or rubber, etc.), which may collectively define one or more circuits to provide power the electronic components, such as electronic component 408. In some examples, one or more electronic components may be disposed in, on, and/or between one of the layers of the sheets of material.

The one or more intermediate layers may be comprised of one or more structurally reinforcing materials (e.g., foam rubber, silicone, metal wire mesh, carbon fiber, woven boron nitride nanotubes, etc.), to provide additional strength and support to the wallpaper module. For example, the one or more intermediate layers may include reinforced fiber (e.g., fiber-reinforced with glass, cellulose, carbon, meal, and/or other natural or synthetic fibers). In such cases, the fibers may be woven or non-woven. Further, the wallpaper modules may include various configurations of layers depending on an intended use of the wallpaper modules. For example, the wallpaper modules may contain a different number of layers, a different positions of the layers, and/or different combinations of layers, to name a few examples.

In some examples, the wallpaper module may contain one or more electrical conductors, such as disposed on the one or more layers, to connect the electronic components and to form one or more circuits. For example, the electrical conductors may include one or more wires, traces, strips, sheets, fibers, coatings, nanoparticles, inks, doped regions, to name a few non-limiting examples. The electrical conductors comprise of one or more metals (e.g., copper, silver, steel, aluminum, gold, etc.), doped or infused plastics, intrinsically conductive polymers, and/or any other materials or combinations of materials capable of conducting electricity. In some examples, the conductive materials may be applied to the one or more layers of the wallpaper module by weaving one or more wires and/or other fibers into the one or more layers. In other examples, the conductive material may be applied by stamping and/or rolling a thin sheet of conductive material to at least a portion of a layer. In some examples, the conductive materials may be applied to one or more layers of the sheets of material via a printing process, such as a screen printing process using conductive inks, a three-dimensional printing process using a metal or filament infused with conductive material.

In some examples, the conductors can be formed by applying a conductive material to at least a portion of a layer. One or more circuits may then be formed by segmenting, cutting, and/or removing the conductive material at one or more locations on the layer during manufacturing to create a circuit layer. For example, the conductive layer may be a printed-on layer of conductive material on a dielectric medium. The conductive layer may then be cut, etched, washed, abraded, and/or otherwise removed and filled with one or more non-conductive materials to create a smooth layer with embedded circuits. In some examples, conductors in one layer may be electrically connected to conductors in other layers by electrical traces, vias, and/or other interlayer conductors.

The conductors may facilitate a coupling of electronic components to the wallpaper module. For example, the wallpaper module 400 may include a dock plate 410. The dock plate 410 may include one or more ferromagnets 412, which may be comprised of any ferromagnetic material, such as iron or steel. The one or more ferromagnets 412 may, in some examples, serve as an anchor to maintain the position of the dock plate 410 when the dock plate is coupled to an electronic component 408, such as a switch.

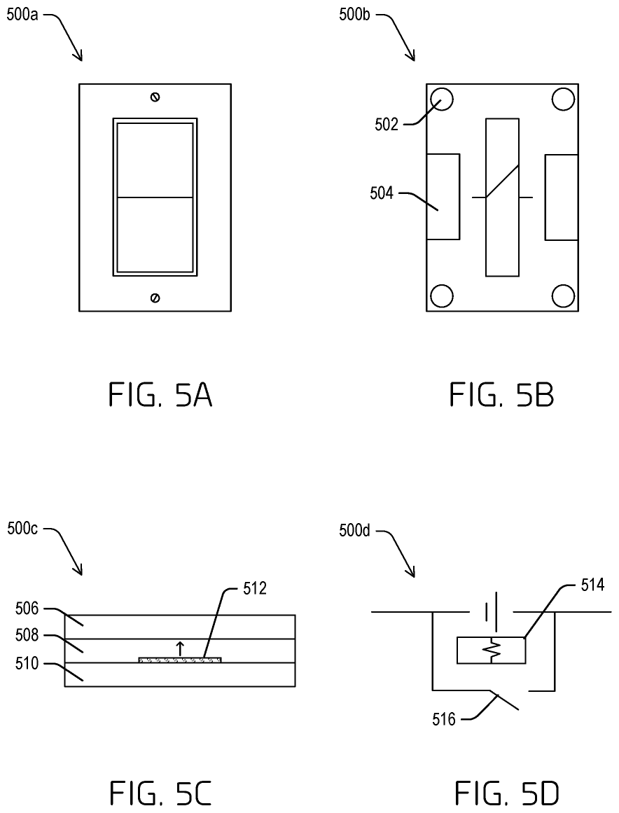

FIGS. 5A-5D illustrate schematic views of example switches and other electronic components that may be coupled to a wallpaper module. As described above, any number of switches and/or electronic components may be physically and/or electrically coupled to a wallpaper module. By way of example and not limitation, the switch may include a mechanical switch (e.g., on/off, two-position, three-position, etc.), a dimmer switch or rheostat, a sensor (e.g., a passive sensor, a touch sensor, a light sensor, a radio frequency sensor, a motion sensor, a microphone or audio sensor, a temperature sensor, etc.), and/or a computed state in a programmable integrated circuit or gate array. The computed state may include, for example, a programmed lighting pattern or animation, programmed audio presentation, combinations of these, or the like. In the case of a light sensor, the light sensor may detect visible light, infrared light, or other visible or non-visible light spectrums.

FIG. 5A illustrates a top view of an example switch 500a. It may be noted that while a switch is depicted in the current illustration, any electronic component may be used and connected to the circuit in the same or similar fashion. For example, the switch 500a may be a physical switch, such that physically moving the switch 500a to an off or an on position may open or close a circuit, turning an electronic component connected to the circuit off or on. Similar to the wallpaper module, the switch 500a may be connected to the circuit via a trace and may be adhered to the surface of the wallpaper module and/or to the wall or other supporting surface.

FIG. 5B illustrates a bottom-view of an example switch 500b, similar to switch 500a. For example, the switch 500b may be coupled to a dock, such as docks 304a, 304b, 304c, 306a, 306b, 306c, and/or 306d, as depicted in FIG. 3. In some examples, the switch or electronic components may include one or more magnetic anchors, such as anchor 502. The magnetic anchor may be comprised of a permanent magnetic or electromagnetic material, or a material that is magnetically attracted thereby. The anchor(s) 502 may be used to secure the switch or electronic component to the dock. Examples of permanent magnets that can be used include, for example, aluminum-nickel-cobalt (alnicos), strontium-iron (ferrites, also known as ceramics), neodymium-iron-boron (also known as neodymium magnets), and samarium-cobalt magnets. In some examples, the switches or electronic components may include the permanent magnet(s) and/or electromagnet(s) while the dock includes a ferromagnetic material (e.g., iron or steel), while in some examples the dock includes the permanent magnet(s) and/or electromagnet(s) while the switch or electronic component includes the ferromagnetic material.

The switch may also contain one or more contacts, such as 504, which may electrically connect the switch to the dock. In some examples, the contacts 504 may additionally or alternatively be magnetic. For example, the contacts 504 may contain at least one of a magnetic or electromagnetic material, and the dock may contain one or more ferromagnetic materials (e.g., iron, nickel, cobalt, gadolinium, neodymium, to name a few non-limiting examples). In other examples, the contacts 504 may contain one or more ferromagnetic materials, while the dock may contain at least one of magnetic and/or electromagnetic materials.

FIG. 5C illustrates a side view of an example wallpaper module 500c in the presence of an electronic component (not pictured). For example, the electronic component may be the switch 500a and/or 500b, or any electronic component described herein. As described above, the wallpaper module 500c may contain multiple layers, such as a top layer 506, one or more intermediate layers 508, and a bottom layer 510. In some examples, the intermediate layer may contain a docking point, such as docking point 512. The docking point may comprise one or more ferromagnetic materials, such that when subject to a magnetic field, the one or more ferromagnetic materials are drawn to the magnetic field. In some examples, the docking point may contain a reed switch (not pictured). For example, the reed switch may contain two overlapping wires or traces. When not exposed to a magnetic field, the two wires or traces may remain separated, leaving the circuit open, as illustrated in FIG. 5B. However, when exposed to a magnetic field, the two wires or traces may overlap or contact, causing the circuit to close. In response to a magnetic field, such as that induced by a magnet included in an electronic component, the ferromagnetic material may be drawn to the magnetic field, thus completing the circuit.

FIG. 5D illustrates a schematic diagram of a magnetically actuated dock 500d which includes a magnet 514 and a switch dock 516. When no electronic component is coupled to the magnetically actuated dock 500d, the magnet 514 biases the switch dock 516 to a closed position to complete the circuit. Thus, when nothing is connected to the magnetically actuated dock 500d, electricity simply passes through the dock and the dock acts as a conductor. However, when an electronic component is coupled to the magnetically actuated dock 500d, a magnetic field imparted by a permanent magnet or an electromagnet of electronic component displaces the magnet 514 and causes the switch dock 516 to open, thereby causing electricity to flow through the electronic component.

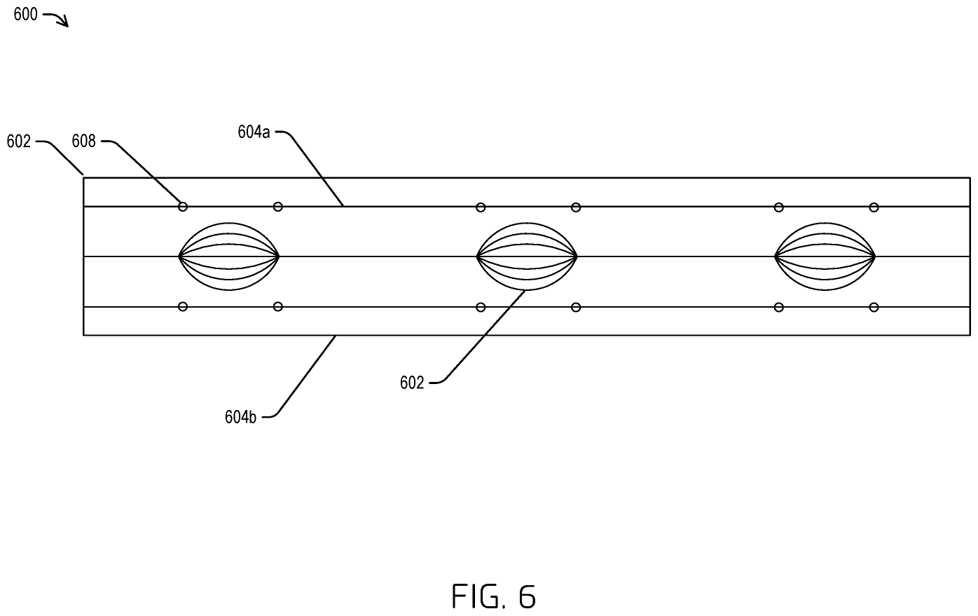

FIG. 6 illustrates a schematic diagram 600 of an example cable routing sheath that may be integrated into a wallpaper module in a circuit. For example, the cable routing sheath, such as sheath 602, may be used as a decorative layer to conceal one or more wires or traces in a circuit and/or one more cables (e.g., USB, Firewire, Ethernet, HDMI, etc.) similar to a traditional conduit. For example, the cable routing sheath may include one or more decorative elements and may resemble, to name a few non-limiting examples, crown molding, hollow trim, and/or baseboards. The cable routing sheath may be attached to any surface in which the circuit may be present, such as, for example, a wall or ceiling. In some examples, the cable routing sheath may contain a removable adhesive material and/or fasteners such that the cable routing sheath may adhere to any surface.

In some examples, the cable routing sheath may be removed from the circuit. In other words, the cable routing sheath may be placed over the circuit to conceal the traces. However, the circuit may additionally or alternatively be integrated into the cable routing sheath, as depicted in the cable routing sheath 602. For example, the cable routing sheath may contain one or more traces that may connect the one or more wallpaper modules. The traces may be comprised of any conductive material, such as copper and/or iron, for example. In some examples, the cable routing sheath may contain two or more traces arranged in a twisted pair, such as the traces 604a and 604b. Arranging the traces in such a configuration may improve the transport efficiency of power through the circuit. In some examples, the traces may facilitate the use of data communications and voice communications, to name a few examples.

In some examples, the cable routing sheath may include one or more outlets docks, such as outlet dock 606. For example, the cable routing sheath may be used as trim. The one or more traces may be arranged in one or more specific locations and/or patterns such that the circuit may incorporate existing outlets and/or additional outlets may be added to the circuit, such as on the cable routing sheath. Because the addition of an outlet does not interrupt a normal flow of electricity, the outlet may not require the use of a switch. In some examples, a new outlet to be added to the cable routing sheath may include one or more conductive fasteners. The conductive fasteners may be of a length, sharpness, and/or material, such as copper and/or iron, such that they may penetrate at least a portion of the cable routing sheath. In some examples, the cable routing sheath may contain one or more markers, such as marker 608, which may provide an indication of where the one or more spikes should be placed. The conductive fasteners may be punched into the cable routing sheath, physically coupling to one or more traces within the cable routing sheath, thus connecting the outlet.

FIGS. 7A-7D are schematic diagrams illustrating contact points and electrical interfacing docks for connecting electronic components to a module, for connecting adjacent modules, and/or for connecting a module to a conduit or other component, such as cable routing sheath 602. For example, as described above with respect to FIG. 3, electronic components may be coupled to one or more docks of a wallpaper module by magnetic attachment, fasteners, snap-fit connections, press-fit connections, adhesives, and hook and loop fasteners, to name a few examples.

FIG. 7A is a schematic diagram 700a illustrating an electronic component coupled to a wallpaper module using conductive fasteners. However, it may be noted that conductive fasteners may be used to couple one or more of any of the components described in this application, such as, but not limited to, wallpaper modules, electronic components, cable routing sheaths, etc. For example, a wallpaper module 702 may contain a conductive layer 704. In some examples, one or more magnetic and/or ferromagnetic materials may be disposed below at least a portion of the conductive layer 704, such as a magnet 706 and a ferromagnetic material 708. Additionally, the wallpaper module may include one or more electrically conductive fasteners 710. Similarly, an electronic component 712 may be the same or complimentary to the wallpaper module 702. For example, the electronic component may include one or more conductive layers 714 and one or more magnets 716, one or more ferromagnetic materials 718, and one or more conductive fasteners 720. As described above, in some examples, the ferromagnetic materials 708 and 718 may be magnetically attracted to the one or more magnets 706 and 716. Thus, in some examples, the wallpaper module 702 and the electronic component 712 may be aligned such that at least a portion of the magnet 706 of the wallpaper module 702 may be aligned with the ferromagnetic material of the electronic component 712, and at least a portion of the ferromagnetic material 708 of the wallpaper module 702 may be aligned with the magnet 716 of the electronic component 712. Thus, the ferromagnetic material 708 of the wallpaper module 702 may be attracted to the magnet 716 of the electronic component 712 and/or the ferromagnetic material 718 of the electronic component 712 may be attracted to the magnet 706 of the wallpaper module 702, causing a magnetic connection between the wallpaper module 702 and the electronic component 712.

To establish an electrical connection between the wallpaper module 702 and the electronic component 712, the one or more conductive fasteners 710 of the wallpaper module may pierce through one or more layers of the electronic component (e.g., a decorative layer) to contact the conductive layer 714 of the electronic component. Similarly, the one or more conductive fasteners 720 of the electronic component 712 may pierce through one or more layers of the wallpaper module 702 to contact the conductive layer 704 of the wallpaper module 702, establishing an electrical connection between the wallpaper module 702 and the electronic component 712.

FIG. 7B is a schematic diagram illustrating 700b an example electronic component coupled to wallpaper module using an electrically conductive hook and loop fastening system (e.g., Velcro® or other Hook and Loop Tape), such as hooks 722 and loops 724. For example, the hooks 722 and/or the loops 724 may be coupled to one or more of any of the components described in this application, such as, but not limited to, wallpaper modules, electronic components, cable routing sheaths, etc. In some examples, a surface of the hooks 722 and/or the loops 724 may comprise one or more conductive materials. For example the surface of the hooks 722 and/or the loops 724 may be coated with a conductive materials, such as silver, such that when the hook 722 and the loop 724 come into contact with one another, they may be electrically coupled.

FIG. 7C is a schematic diagram 700c illustrating an example electronic component coupled to a wallpaper module using conductive snaps, such as a snap stud 726 and a snap socket 728. Similar to FIG. 7B, conductive snaps may be coupled to one or more of any of the components described in this application, such as but not limited to, wallpaper modules, electronic components, cable routing sheaths, etc. In some examples, a surface of the snap stud 726 and/or the snap socket 728 comprise one or more conductive materials, such that when the snap stud 726 and/or the snap socket 728 come into contact with one another, they may be electrically coupled.

In some examples, a user may desire to not just couple an electronic component to a wallpaper module, but couple multiple wallpaper modules together. For example, while a wallpaper module may be used as a standalone unit, multiple wallpaper modules may be coupled to one another directly or indirectly to create a larger, standalone unit. For example, adjacent wallpaper modules may be electrically connected by one or more electrical connection points located along a periphery of the wallpaper modules. In some examples, the wallpaper modules may be physically coupled. For example, the wallpaper modules may be coplanar and adjacent to one another, disposed on top of one another, and/or may be disposed in a partially overlapping configuration. Additionally or alternatively, wallpaper modules and/or the circuits contained therein may be electromagnetically coupled (e.g., physically and/or inductively). Coupling multiple wallpaper modules together may enable lighting or other electronic components to be placed throughout a large area (e.g., a portion of a wall, an entire wall, a portion of a ceiling, an entire ceiling, portions of one or more walls and/or the ceiling, an entire room, an entire house, etc.). In some examples, individual wallpaper modules may include one or more lighting and/or other electronic components, or may simply include wiring to conduct electricity from a source to an electronic component another wallpaper module.

FIG. 7D is a schematic diagram 700d illustrating two wallpaper modules connected via a conductive paste. For example, a first wallpaper module, such as a first wallpaper module 730, may have an edge 732. A second wallpaper module 734 may have a second edge 736. In some examples, the first edge 732 and the second edge 736 may be configured such that when in contact with one another, the first edge 732 may fit flush with the second edge 736. The edges 732 and 736 may be flat, rounded, and/or diagonal, to name a few non-limiting examples. In some examples, the edges 732 and 736 may comprise one or more conductive materials. For example, a conductive paste may be applied to the one or more edges 732 and 736. The conductive material may comprise an adhesive material (e.g., glue) and/or one or more conductive materials (e.g., iron, copper, silver, etc.) such that when the first wallpaper module 730 and the second wallpaper module 734 come into contact, they may physically and electrically couple to one another.

While the examples shown in FIGS. 1-3 are illustrated as spanning all or a portion of a wall of a room, in practice the wallpaper modules according to this application can be any suitable size (larger or smaller than that illustrated). In some examples, wallpaper modules according to this disclosure may have an area of at least about 8 square feet (or at least about 0.7 square meters), though larger or smaller areas are possible. In some examples, the wallpaper modules may be made in standardized, modular sizes and multiple wallpaper modules can be applied as needed to fit a desires space. The multiple wallpaper modules may, but need not necessarily, be electrically connected to one another. By way of example and not limitation, wallpaper modules according to this disclosure may be provided having a first dimension (e.g., width) of 1 foot, 2 feet, 3 feet, 4 feet, 6 feet, 8 feet, 12 feet, 1 meter, 2 meters, 3 meters, or 4 meters, and a second dimension (e.g., length) of 1 foot, 2 feet, 3 feet, 4 feet, 6 feet, 8 feet, 12 feet, 16 feet, 1 meter, 2 meters, 3 meters, 4 meters, 5 meters, 6 meters, etc. In some examples, the circuits may not extend all the way to the edge of the wallpaper module. In that case, the material outside the circuit can be removed to size the wallpaper module to fit the desired space.

Alternatively, in some examples, the wallpaper may be provided in rolls that can be cut to fit the desired length. To maintain a complete circuit while allowing the wallpaper to be cut, the wallpaper may include a separate edge strip depending on a configuration of the wallpaper modules, as described with more detail in FIG. 2. For example, wallpaper modules coupled in series may require a separate edge, while wallpaper modules coupled in parallel and/or via coupled transformers may not require an edge strip, but rather include significant fusing and guidance.

The thickness of wallpaper modules according to this application may vary depending on the number of layers and the material used. However, in order to maintain its flexibility and compliance, in at least some examples the wallpaper may have a thickness of less than about 2 millimeters (mm). However, in other examples, the wallpaper modules may have thicknesses greater or less than this (e.g., 0.05 mm, 0.1 mm, 0.5 mm, 1.0 mm, 5.0 mm, etc.)

As described above, the modules or other components of the system may include one or more wired or wireless communication connection(s) that enable communication with one or more other local or remote computing device(s). For instance, the communication connection(s) may facilitate communication with local computing device(s) coupled to the modules, other nearby computing devices via a local area network, and/or other remote computing devices via connection to the Internet. In some examples, an LC circuit comprising an inductor (L) connected to a capacitor (C) may be embedded directly into the wallpaper module to act as an electrical resonator, and/or may be located on the one or more electronic components. Additionally or alternatively, communication(s) may be placed in a separate location, such as a separate box, such that the system may include one or more plug-in modules to allow for interchangeability and upgradability of the one or more controllers, communication modules, etc. Additionally, in some examples, one or more layers of padding may be located within the wallpaper module to compensate for and hide larger embedded components such as electrolytic capacitors.

The communications connection(s) may include physical and/or logical interfaces for connecting to another computing device or a network. For example, the communications connection(s) may enable Wi-Fi-based communication such as via frequencies defined by the IEEE 802.11 standards, short-range wireless frequencies such as Bluetooth, near field communication (NFC), cellular communication (e.g., 2G, 3G, 4G, 4G LTE, 5G, etc.), power line communication (PLC), or any suitable wired or wireless communications protocol that enables the respective computing device to interface with the other computing device(s).

The modules or other electronic components coupled to the modules may also include one or more processors and/or memory to store executable instructions. The processor(s) may be any suitable processor capable of executing instructions to process data and perform operations as described herein. By way of example and not limitation, the processor(s) may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The memory may be non-transitory computer-readable media and may store an operating system and one or more software applications, instructions, programs, and/or data to implement the methods described herein and the functions attributed to the various systems. In various implementations, the memory may be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A wallpaper system comprising:
a top layer comprising a dielectric material;
a bottom layer to be adhered to a surface; and
an intermediate layer disposed between the top layer and the bottom layer;
an electronic component coupled to at least one of the top layer, the bottom layer, or the intermediate layer; and
a conductor disposed within or on at least one of the intermediate layer or the bottom later, the conductor coupled to the electronic component, the conductor being configured to provide power from a power supply to the electronic component.

2. The wallpaper system of claim 1, further comprising a dock disposed in or top layer and coupling the electronic component to the conductor.

3. The wallpaper system of claim 2, wherein the dock comprises an electrical disconnect.

4. The wallpaper system of claim 1, wherein the electronic component comprises at least one of:
a light;
a receptacle;
a switch;
a sensor;
a motor;
a speaker;
a coupler;
a disconnect;
a dock;
a power supply;
a processor;
a memory;
a wired communication connection;
a wireless communication connection;
a capacitor;
an inductor;
a resistor; or
an amplifier.

5. The wallpaper system of claim 1, wherein the top layer comprises at least one of:
a wallpaper;
a fabric; or
a sticker.

6. The wallpaper system of claim 1, wherein at least one of the top layer, the intermediate layer, or the bottom layer is at least one of a flexible or compliant material.

7. The wallpaper system of claim 1, wherein the electronic component is coupled to at least one of the top layer, the bottom layer, or the intermediate layer by at least one of:
a conductive paste;
a conductive fastener; or
a conductive hook and loop.

8. The wallpaper system of claim 1, wherein the top layer comprises a grounded shielding.

9. The wallpaper system of claim 1, wherein the conductor is disposed within at least one of the top layer, the intermediate layer, or the bottom layer.

10. A system comprising:
a flexible sheet of material to be adhered to a surface;
an electronic component coupled to the flexible sheet of material; and
a conductor disposed within or on the flexible sheet of material and coupled to the electronic component, the conductor being configured to provide power from a power supply to the electronic component.

11. The system of claim 10, wherein the flexible sheet of material comprises a top layer made of a dielectric material.

12. The system of claim 11, wherein the flexible sheet of material further comprises a bottom layer comprising an adhesive.

13. The system of claim 12, wherein the flexible sheet of material further comprises an intermediate layer disposed between the top layer and the bottom layer, and wherein the conductor is disposed in or in contact with the intermediate layer.

14. The system of claim 13, wherein the conductor is a first conductor and is disposed in or on the intermediate layer, the system further comprising a second conductor disposed in or on the top layer or the bottom layer, the second conductor being electromagnetically coupled to the first conductor.

15. The system of claim 10, further comprising a dock disposed in or on the flexible sheet of material and coupling the electronic component to the conductor.

16. The system of claim 15, wherein the dock comprises an electrical disconnect.

17. The system of claim 10, wherein the flexible sheet of material comprises a first flexible sheet of material, the electronic component comprises a first electronic component, and the conductor comprises a first conductor, the system further comprising:
a second flexible sheet of material;
a second electronic component coupled to the second flexible sheet of material; and
a second conductor coupled to the second electronic component and configured to receive power from the first conductor and provide power to the second electronic component.

18. The system of claim 10, wherein the electronic component is coupled to the flexible sheet of material by at least one of:
a conductive paste;
a conductive fastener; or
a conductive hook and loop.

19. A system comprising:
a first wallpaper module comprising:
a first sheet of material;
a first electronic component coupled to the first sheet of material; and
a first conductor coupled to the first electronic component, the first conductor being configured to provide power from a power supply to the first electronic component; and
a second wallpaper module coupled to the first wallpaper module, the second wallpaper module comprising:
a second sheet of material;
a second electronic component coupled to the second sheet of material; and
a second conductor coupled to the second electronic component, the second conductor being configured to provide power from the power supply to the second electronic component.

20. The system of claim 19, wherein the first wallpaper module is coupled to the second wallpaper module by at least one of:
a conductive paste;
a conductive fastener; or
a conductive hook and loop.

21. The system of claim 19, wherein the first wallpaper module and the second wallpaper module are disposed in at least a partially overlapping configuration.

22. The system of claim 19, wherein the first wallpaper module is coupled to the second wallpaper module via an electromagnetic coupling.
